(19) United States
(12) Patent Application Publication
(10) Pub. No.: US 2020/0331098 A1
(43) Pub. Date: Oct. 22, 2020

(54) LASER CLAD-WELDING METHOD AND LASER CLAD-WELDING APPARATUS

(71) Applicant: TOYOTA JIDOSHA KABUSHIKI KAISHA, Toyota-shi (JP)

(72) Inventors: Naruya Tsuji, Toyota-shi (JP); Yusuke Oishi, Toyota-shi (JP)

(73) Assignee: TOYOTA JIDOSHA KABUSHIKI KAISHA, Toyota-shi (JP)

(21) Appl. No.: 16/810,933

(22) Filed: Mar. 6, 2020

(30) Foreign Application Priority Data
Apr. 19, 2019 (JP) 2019-080108

(51) Int. Cl. B23K 26/34; B23K 26/144

(52) U.S. Cl. CPC B23K 26/34; B23K 26/0823; B23K 26/144

(57) ABSTRACT

In a laser clad-welding method, a laser torch is moved so that a distance from a central axis of a countersunk groove to an irradiation locus of a laser beam falls within a first distance range within which a partitioning wall located between adjacent countersunk grooves does not melt down in a part of the countersunk groove on a center side of the combustion chamber, and a distance from the central axis of the countersunk groove to an irradiation locus of the laser beam falls within a second distance range within which a prescribed processing allowance is ensured with respect to a target interface in a part of the countersunk groove on an outer circumference side of the combustion chamber in a process of forming a cladding layer by irradiating a laser beam to the countersunk groove while feeding metal powder to the countersunk groove.

### CROSS REFERENCE TO RELATED APPLICATIONS

This application is based upon and claims the benefit of priority from Japanese patent application No. 2019-080108, filed on Apr. 19, 2019, the disclosure of which is incorporated herein in its entirety by reference.

### BACKGROUND

The present disclosure relates to a laser clad-welding method and a laser clad-welding apparatus.

A laser cladding process of cladding a metal material that has an excellent abrasion resistance property on a processed part of a valve sheet of a cylinder head is known. The laser cladding process is a technique in which a laser beam is irradiated to a processed part of a sheet valve while feeding metal powder thereto, whereby the processed part is melted and solidified. In order to perform cladding of the processed part by irradiating the laser beam while feeding the metal powder thereto, the laser beam needs to be relatively moved along the processed part. Japanese Unexamined Patent Application Publication No. 2005-299598 discloses a technique of moving a semiconductor laser light and a nozzle for feeding copper alloy powder on a circular path while gradually increasing the feeding amount of the copper alloy powder and increasing the output of the semiconductor laser light in accordance with the feeding amount of the copper alloy powder at the start of cladding.

### SUMMARY

The technique disclosed in Japanese Unexamined Patent Application Publication No. 2005-299598 is employed for a procedure at the start of cladding when the feeding amount of the metal powder is unstable. However, the inventors of the present disclosure have found that there are cases where even when an appropriate procedure is taken at the start of cladding, a defect occurs in a cladding layer or its surrounding.

The present disclosure has been made in view of the background mentioned above and one of objects thereof is to provide a laser clad-welding method and a laser clad-welding apparatus by which occurrence of a defect in a cladding layer or its surrounding can be prevented.

An exemplary aspect according to an embodiment is a laser clad-welding method including: a first process of forming, in a blank of a cylinder head in which a hemispherical combustion chamber is formed and a plurality of port holes are radially formed in the combustion chamber, an annular countersunk groove along an outer circumference of each of the plurality of port holes; and a second process of forming a cladding layer for a valve sheet by making a central axis of the countersunk groove coincide with a vertical direction and irradiating a laser beam to the countersunk groove while feeding metal powder to the countersunk groove, in which in the second process, a laser torch for irradiating the laser beam is moved so that a distance from the central axis of the countersunk groove to an irradiation locus of the laser beam falls within a first distance range within which a partitioning wall located between adjacent countersunk grooves does not melt down in a part of the countersunk groove on a center side of the combustion chamber, and a distance from the central axis of the countersunk groove to an irradiation locus of the laser beam falls within a second distance range within which for an interface of the welded cladding layer, a prescribed processing allowance is ensured with respect to a target interface in a part of the countersunk groove on an outer circumference side of the combustion chamber.

By this configuration, an interface of the welded cladding layer can be made an ideal interface. Accordingly, the processing allowance measured from the target interface of the cladding layer can be adjusted to the minimum necessary processing allowance on both a combustion chamber wall side and a partitioning wall side. Further, it is possible to prevent poor quality which would otherwise be caused by the clad-welding such as an edge of the partitioning wall melting down due to excessive heat from the laser beam.

Further, a laser torch may be moved so that the irradiation locus of the laser beam between the irradiation locus of the laser beam irradiated to a part of a countersunk groove on the center side of the combustion chamber and the irradiation locus of the laser beam irradiated to a part of the countersunk groove on the outer circumference side of the combustion chamber becomes linear. By this configuration, the irradiation locus of the laser beam irradiated to a part of the countersunk groove on the partitioning wall side and the irradiation locus of the laser beam irradiated to a part of the countersunk groove on the combustion chamber wall side can be smoothly joined with each other.

Another exemplary aspect according to an embodiment is a laser clad-welding method including: a first process of forming, in a blank of a cylinder head in which a hemispherical combustion chamber is formed and a plurality of port holes are radially formed in the combustion chamber, an annular countersunk groove along an outer circumference of each of the plurality of port holes; and a second process of forming a cladding layer for a valve sheet by making a central axis of the countersunk groove coincide with a vertical direction and irradiating a laser beam to the countersunk groove while feeding metal powder to the countersunk groove, in which in the second process, the blank is moved so that a distance from the central axis of the countersunk groove to an irradiation locus of the laser beam falls within a first distance range within which a partitioning wall located between adjacent countersunk grooves does not melt down in a part of the countersunk groove on a center side of the combustion chamber, and a distance from the central axis of the countersunk groove to an irradiation locus of the laser beam falls within a second distance range within which for an interface of the welded cladding layer, a prescribed processing allowance is ensured with respect to a target interface in a part of the countersunk groove on an outer circumference side of the combustion chamber.

By this configuration, an interface of the welded cladding layer can be made an ideal interface. Accordingly, the processing allowance measured from the target interface of the cladding layer can be adjusted to the minimum necessary processing allowance on both the combustion chamber wall side and the partitioning wall side. Further, it is possible to prevent poor quality which would otherwise be caused by the clad-welding such as an edge of the partitioning wall melting down due to excessive heat from the laser beam.

Further, a blank may be moved so that the irradiation locus of the laser beam between the irradiation locus of the laser beam irradiated to the part of the countersunk groove on the center side of the combustion chamber and the irradiation locus of the laser beam irradiated to the part of the countersunk groove on the outer circumference side of the combustion chamber becomes linear. By this configuration, the irradiation locus of the laser beam irradiated to the part of the countersunk groove on the partitioning wall side and the irradiation locus of the laser beam irradiated to the part of the countersunk groove on the combustion chamber wall side can be smoothly joined with each other.

Another exemplary aspect according to an embodiment is a laser clad-welding apparatus including: a positioning part configured to position a blank of a cylinder head in which a plurality of port holes are radially formed in a hemispherical combustion chamber and an annular countersunk groove is formed along an outer circumference of each of the plurality of port holes; a metal powder feeding part configured to feed metal powder to the countersunk groove; a laser beam irradiation part configured to form a cladding layer in the countersunk groove by irradiating a laser beam to the metal powder and thereby melting the metal powder; a rotary moving part configured to rotate a laser torch in the laser beam irradiation part; a linear moving part configured to linearly move the laser torch; and a control part configured to control actions of the positioning part, the metal powder feeding part, the laser beam irradiation part, the rotary moving part, and the linear moving part, in which the control part controls: the action of the positioning part so that a central axis of the countersunk groove coincides with a vertical direction; the actions of the metal powder feeding part and the laser beam irradiation part so that the laser beam is irradiated to the countersunk groove while feeding the metal powder to the countersunk groove; and the actions of the rotary moving part and the linear moving part so that while the laser beam is being irradiated, a distance from the central axis of the countersunk groove to an irradiation locus of the laser beam falls within a first distance range within which a partitioning wall located between adjacent countersunk grooves does not melt down in a part of the countersunk groove on a center side of the combustion chamber, and a distance from the central axis of the countersunk groove to an irradiation locus of the laser beam falls within a second distance range within which for an interface of the welded cladding layer, a prescribed processing allowance is ensured with respect to a target interface in a part of the countersunk groove on an outer circumference side of the combustion chamber.

By this configuration, an interface of the welded cladding layer can be made an ideal interface. Accordingly, the processing allowance measured from the target interface of the cladding layer can be adjusted to the minimum necessary processing allowance on both the combustion chamber wall side and the partitioning wall side. Further, it is possible to prevent poor quality which would otherwise be caused by the clad-welding such as an edge of the partitioning wall melting down due to excessive heat from the laser beam.

Another exemplary aspect according to an embodiment is a laser clad-welding apparatus including: a positioning part configured to position a blank of a cylinder head in which a plurality of port holes are radially formed in a hemispherical combustion chamber and an annular countersunk groove is formed along an outer circumference of each of the plurality of port holes; a metal powder feeding part configured to feed metal powder to the countersunk groove; a laser beam irradiation part configured to form a cladding layer in the countersunk groove by irradiating a laser beam to the metal powder and thereby melting the metal powder; a rotary moving part configured to rotate a laser torch in the laser beam irradiation part; an angle adjustment part configured to adjust an angle of the laser torch with respect to a vertical direction; and a control part configured to control actions of the positioning part, the metal powder feeding part, the laser beam irradiation part, the rotary moving part, and the angle adjustment part, in which the control part controls: the action of the positioning part so that a central axis of the countersunk groove coincides with a vertical direction; the actions of the metal powder feeding part and the laser beam irradiation part so that the laser beam is irradiated to the countersunk groove while feeding the metal powder to the countersunk groove; and the actions of the rotary moving part and the angle adjustment part so that while the laser beam is being irradiated, a distance from the central axis of the countersunk groove to an irradiation locus of the laser beam falls within a first distance range within which a partitioning wall located between adjacent countersunk grooves does not melt down in a part of the countersunk groove on a center side of the combustion chamber, and a distance from the central axis of the countersunk groove to an irradiation locus of the laser beam falls within a second distance range within which for an interface of the welded cladding layer, a prescribed processing allowance is ensured with respect to a target interface in a part of the countersunk groove on an outer circumference side of the combustion chamber.

By this configuration, an interface of the welded cladding layer can be made an ideal interface. Accordingly, the processing allowance measured from the target interface of the cladding layer can be adjusted to the minimum necessary processing allowance on both the combustion chamber wall side and the partitioning wall side. Further, it is possible to prevent poor quality which would otherwise be caused by the clad-welding such as an edge of the partitioning wall melting down due to excessive heat from the laser beam.

According to the present disclosure, it is possible to prevent occurrence of a defect in the cladding layer or its surrounding.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view showing an overall configuration of a laser clad-welding apparatus according to an embodiment;

FIG. 2 is an enlarged diagram of a region A surrounded by the broken lines in FIG. 1;

FIG. 3 is a schematic diagram showing a blank of the cylinder head;

FIG. 4 is a schematic diagram showing a state in which the cladding layer is formed to a processed part of the blank of the cylinder head;

FIG. 5 is a flowchart for explaining a flow of a laser clad-welding method;

FIG. 6 is a schematic diagram for explaining an ideal cladding layer that should be formed to a countersunk groove by employing the laser clad-welding method;

FIG. 7 is a diagram for explaining problems of a laser clad-welding method according to a comparative example;

FIG. 8 is a diagram for explaining problems of the laser clad-welding method according to the comparative example;

FIG. 9 is a diagram for explaining problems of the laser clad-welding method according to the comparative example;

FIG. 10 is a diagram for explaining problems of the laser clad-welding method according to the comparative example;

FIG. 11 is a schematic diagram for explaining a laser clad-welding method;

FIG. 12 is a schematic diagram showing a moving part according to a Modified Example 1; and

FIG. 13 is a schematic diagram showing a moving part and a positioning part according to a Modified Example 2.

### DESCRIPTION OF EMBODIMENTS

The present disclosure is explained hereinbelow with reference to the embodiments, however, the disclosure of the claims is not to be limited thereto. Further, not all of the configurations described in the embodiments are essential in solving the problem mentioned above. For the sake of clarification, the description mentioned below and the figures are omitted or simplified as appropriate. In each figure, the same elements are assigned the same reference symbol and duplicate explanations thereof are omitted as appropriate.

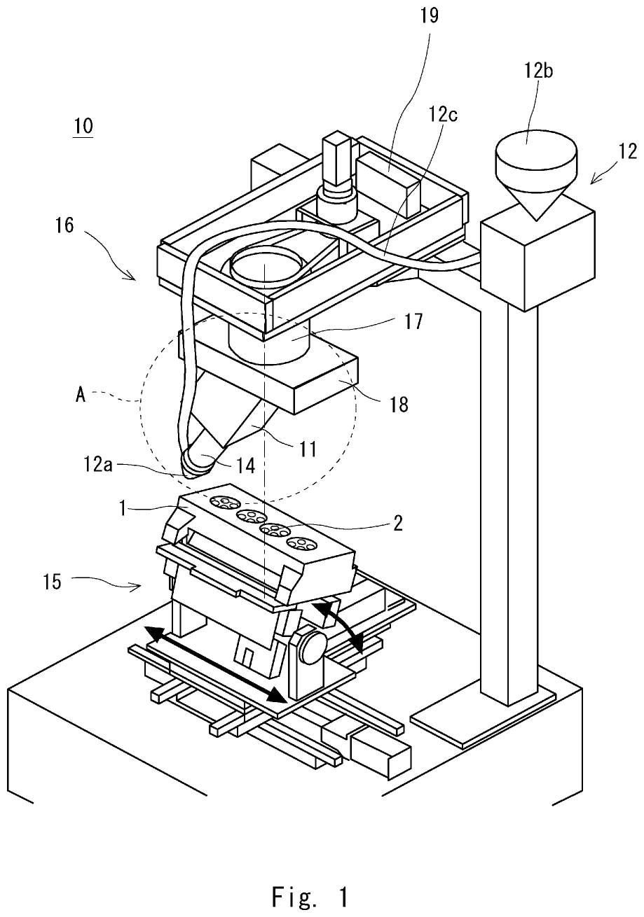

First, an overall configuration of a laser clad-welding apparatus 10 according to this embodiment is explained with reference to FIG. 1.

FIG. 1 is a perspective view of the overall configuration of the laser clad-welding apparatus 10 according to this embodiment. As shown in FIG. 1, the laser clad-welding apparatus 10 includes a laser beam irradiation part 11, a metal powder feeding part 12, a positioning part 15, a moving part 16, and a control part 19.

The positioning part 15 determines a position of a blank 1 of the cylinder head. The blank 1 of the cylinder head is maintained, for example, in a slanted state by the positioning part 15 so that the central axis of the processed part 2 is in the vertical direction. Further, owing to a driving mechanism such as a motor, which is not shown in the figures, the central axis of the processed part 2 and the central axis of a laser torch 14 to be described later can be made to coincide with each other.

The laser beam irradiation part 11 irradiates a laser beam. The laser beam irradiation part 11 includes the laser torch 14. Further, the laser beam irradiation part 11 includes a laser oscillator that generates a laser beam and a laser control part that controls output or the like of the laser beam, neither of which are shown in the figures.

The metal powder feeding part 12 feeds metal powder to the processed part 2. The metal powder feeding part 12 includes a coaxial nozzle 12a provided to a tip end part of the laser torch 14 and through which the laser beam passes and the metal powder is discharged, a pressure-feeding pump 12b, and a hose 12c by which the coaxial nozzle 12a and the pressure-feeding pump 12b are connected. The laser oscillator of the laser beam irradiation part 11 and the coaxial nozzle 12a are integrally connected via an optical system that condenses the laser beam. The pressure-feeding pump 12b measures the amount of metal powder that is held and feeds the metal powder by a prescribed amount to the coaxial nozzle 12a of the laser torch 14 by the pressure of a carrier gas.

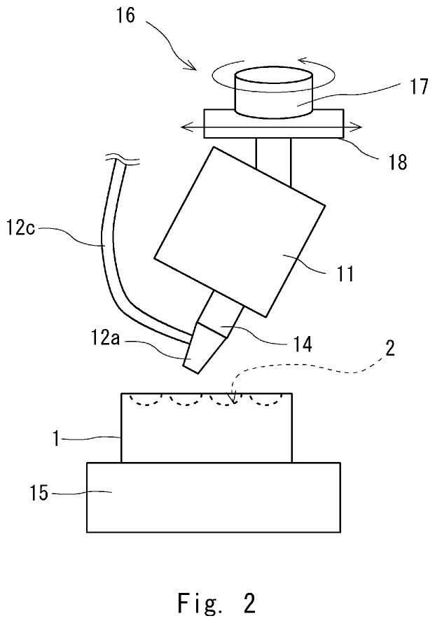

The moving part 16 includes a rotary moving part 17 and a linear moving part 18. FIG. 2 is an enlarged diagram of a region A surrounded by the broken lines in FIG. 1. As shown in FIG. 2, the rotary moving part 17 rotates the laser torch 14 disposed to the laser beam irradiation part 11. Further, the linear moving part 18 linearly moves the laser torch 14 disposed to the laser beam irradiation part 11.

Referring back to FIG. 1, the control part 19 controls the actions of the laser beam irradiation part 11, the metal powder feeding part 12, the positioning part 15, the rotary moving part 17, and the linear moving part 18. First, before starting the laser clad-welding processing, the positioning part 15 makes the central axis of a countersunk groove 33 coincide with the vertical direction based on a control signal transmitted from the control part 19. Further, the positioning part 15 makes the central axis of the countersunk groove 33 coincide with the rotational axis of the laser torch 14 based on the control signal transmitted from the control part 19. During the laser clad-welding processing, the metal powder feeding part 12 adjusts the amount of metal powder fed to the laser torch 14 based on the control signal transmitted from the control part 19. The laser beam irradiation part 11 adjusts the output of the laser beam based on the control signal transmitted from the control part 19. Note that the details of controlling the actions of the rotary moving part 17 and the linear moving part 18 by the control part 19 during the laser clad-welding processing are described later.

Next, the blank 1 of the cylinder head is explained.

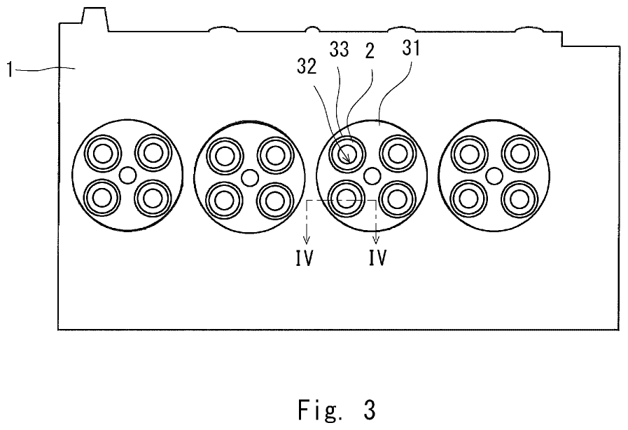

FIG. 3 is a schematic diagram showing the blank 1 of the cylinder head. As shown in FIG. 3, a plurality of port holes 32 are radially formed in a hemispherical combustion chamber 31, and an annular countersunk groove 33 is formed along an outer circumference of each port hole 32 in the blank 1 of the cylinder head. A part of the countersunk groove 33 corresponds to the processed part 2.

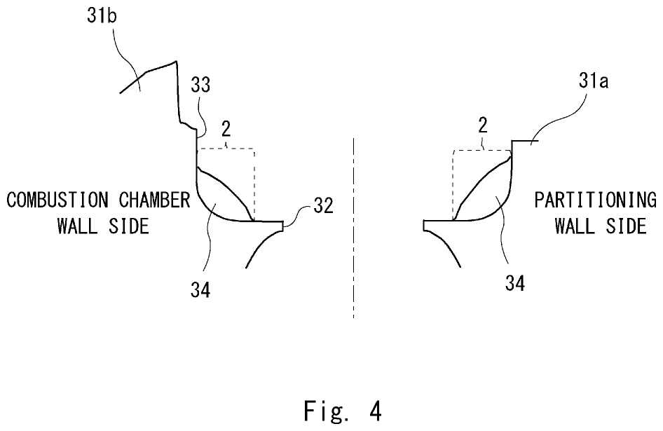

FIG. 4 is a schematic diagram showing a state in which a cladding layer 34 is formed to the processed part 2 of the blank 1 of the cylinder head. Note that FIG. 4 corresponds to a sectional diagram taken along a line Iv-Iv in FIG. 3. In the processed part 2, the cladding layer 34 is formed to the countersunk groove 33 by irradiating the laser beam to the countersunk groove while feeding the metal powder thereto so as to melt the metal powder.

The countersunk grooves 33 that are adjacent to each other are partitioned by a partitioning wall 31a in the combustion chamber 31. That is, the partitioning wall 31a is present in a part of the countersunk groove 33 on the center side of the combustion chamber 31, and a combustion chamber wall 31b is present in a part of the countersunk groove on an outer circumference side of the combustion chamber in the countersunk groove 33. In the explanation given below, the part of the countersunk groove 33 on the center side of the combustion chamber 31 is referred to as a countersunk groove on the “partitioning wall side” and the part of the countersunk groove 33 on the outer circumference side of the combustion chamber 31 is referred to as the countersunk groove on the “combustion chamber wall side”.

Next, a flow of the laser clad-welding method is explained.

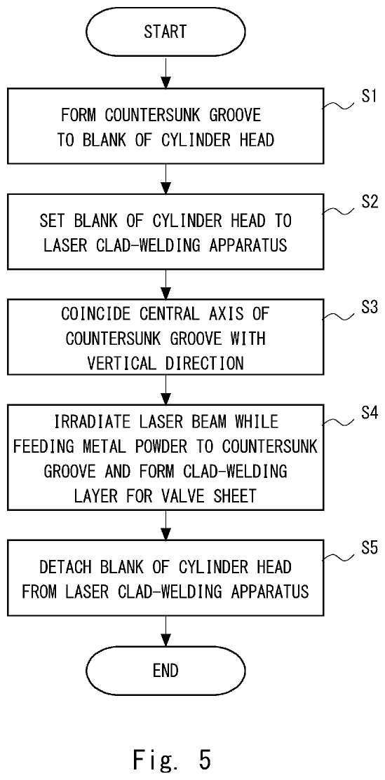

FIG. 5 is a flowchart showing a flow of the laser clad-welding method. As shown in FIG. 5, the annular countersunk groove 33 is formed along the outer circumference of the port hole 32 in the blank 1 of the cylinder head (Step S1). Note that Step S1 is performed before setting the blank 1 of the cylinder head to the laser clad-welding apparatus 10. Next, the blank 1 of the cylinder head is set to the laser clad-welding apparatus 10 (Step S2). Then, the central axis of the countersunk groove 33 is made to coincide with the vertical direction (Step S3). Next, the metal powder is fed to the countersunk groove 33 while irradiating the laser beam thereto and a cladding layer for the valve sheet is formed (Step S4). Then, the blank 1 of the cylinder head is detached from the laser clad-welding apparatus 10 (Step S5).

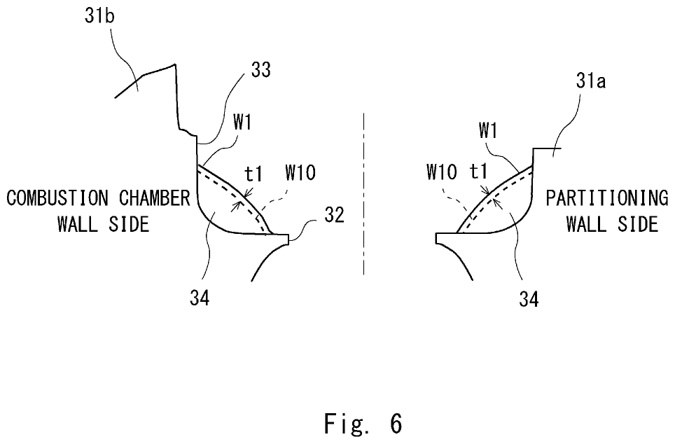

FIG. 6 is a schematic diagram for explaining an ideal cladding layer that should be formed to the countersunk groove 33 by employing the laser clad-welding method. Note that FIG. 6 corresponds to a sectional diagram taken along a line Iv-Iv in FIG. 3. As shown in FIG. 6, the interface of the welded cladding layer 34 needs to have a prescribed processing allowance t1 ensured with respect to the target interface W10. This is because after forming the cladding layer 34 to the countersunk groove 33, the interface of the cladding layer 34 is finishing-processed so that it becomes the target interface W10. That is, the prescribed processing allowance t1 is the minimum necessary allowance for performing the finishing processing to the interface of the welded cladding layer 34 so as to bring it to the target interface W10. The processing allowance of the interface of the welded cladding layer 34 with respect to the target interface W10 suffice as long as it is equal to or larger than the prescribed processing allowance t1, however, if the processing allowance is taken more than required, the cost of the materials runs up to a large sum. Therefore, it is ideal that the processing allowance of the interface of the welded cladding layer 34 is brought to be the prescribed processing allowance t1. Note that in the explanation given below, the interface of the welded cladding layer 34, the allowance of which is brought to be the prescribed processing allowance t1 with respect to the target interface W10, is referred to as an “ideal interface W1”.

Here, the problems of the laser clad-welding method according to a comparative example is explained.

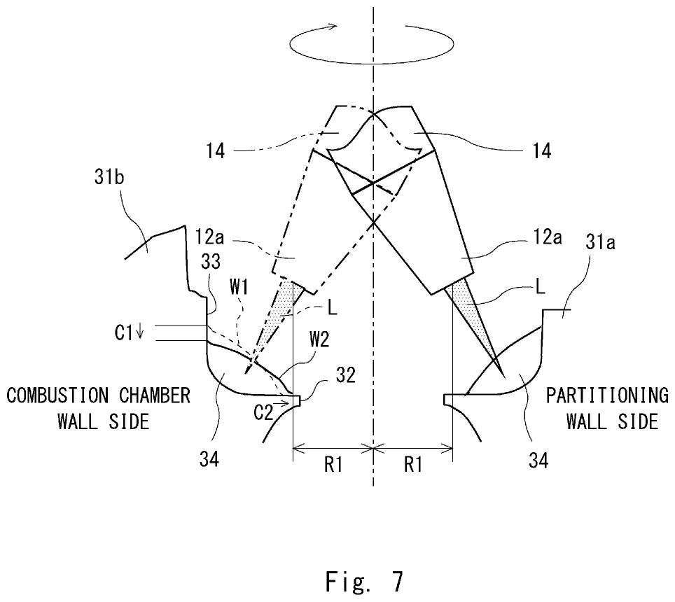

FIGS. 7 to 10 are diagrams for explaining the problems of the laser clad-welding method according to the comparative example. As shown in FIG. 7, in the clad-welding method according to the comparative example, the central axis of the countersunk groove 33 is made to coincide with the rotational axis of the laser torch 14. Then, the laser torch 14 is rotated about the rotational axis so that the laser beam L is irradiated to the countersunk groove 33 while the metal powder is fed to the countersunk groove 33. The distance from the rotational axis to the tip end of the coaxial nozzle 12a (the radius of gyration) is R1, this distance on the combustion chamber wall side being the same as that on the partitioning wall side.

Assume that in the part of the countersunk groove 33 on the partitioning wall side, the interface of the welded cladding layer 34 is made to coincide with the ideal interface of the cladding layer 34. Since a thermal capacity of the countersunk groove 33 is larger on the combustion chamber wall side than that on the partitioning wall side, the temperature of the countersunk groove 33 is less likely to rise on the combustion chamber wall side than on the partitioning wall side when the laser beam L is irradiated to the countersunk groove 33. Accordingly, it takes more time for the metal powder to melt and solidify in the part of the countersunk groove 33 on the combustion chamber wall side than that on the partitioning wall side. Therefore, in the part of the countersunk groove 33 on the combustion chamber wall side, the summit of the interface W2 of the welded cladding layer 34 moves further downwardly in the vertical direction shown by an arrow C1 than the ideal summit of the interface W1 while the cladding layer 34 solidifies. Further, on the combustion chamber wall side, the foot of the interface W2 of the cladding layer 34 moves from the foot of the ideal interface W1 toward the rotational axis shown by an arrow C2. Therefore, a prescribed processing allowance may not be ensured with respect to the target interface by the interface W2 of the welded cladding layer 34 on the combustion chamber wall side.

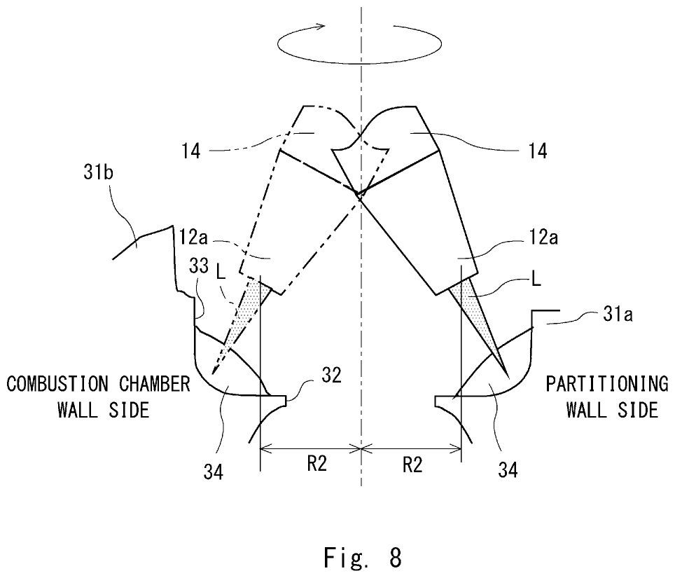

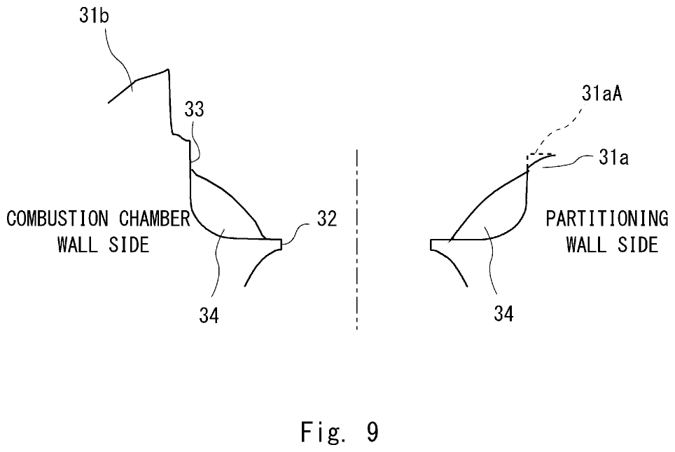

Assume that the radius of gyration of the laser torch 14 is R2, which is larger than R1, as shown in FIG. 8. By this configuration, the interface of the welded cladding layer 34 can be made to coincide with the ideal interface on the combustion chamber wall side. That is, it is possible to move the summit of the interface in the vertically upward direction compared to the case shown in FIG. 7 in which the radius of gyration of the laser torch 14 is R1. Further, the interface of the welded cladding layer 34 can be made to coincide with the ideal interface on the partitioning wall side like in the case shown in FIG. 7. However, in the part of the countersunk groove 33 on the partitioning wall side where the thermal capacity is smaller than that on the combustion chamber wall side, when the laser beam L is irradiated near an edge 31aA of the partitioning wall 31a, the temperature of the edge 31aA becomes too high, thus causing the edge 31aA of the partitioning wall 31a to melt as shown in FIG. 9.

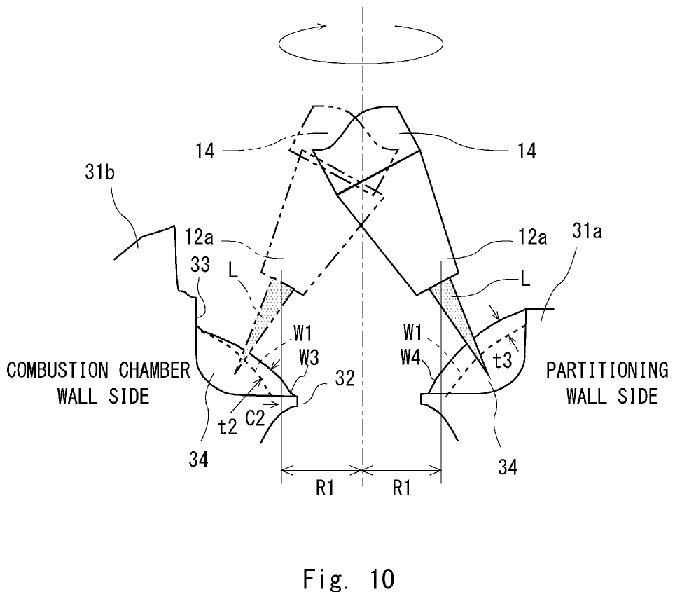

Further, assume that the amount of metal powder fed to the countersunk groove 33 is increased compared to the case shown in FIG. 7. In this case, it is possible to make the position of the summit of the interface W3 of the welded cladding layer 34 coincide with the position of the summit of the ideal interface W1 thereof on the combustion chamber wall side of the countersunk groove 33 as shown in FIG. 10. However, like in the case shown in FIG. 7, on the combustion chamber wall side, the foot of the interface W3 of the cladding layer 34 moves from the foot of the ideal interface W1 toward the rotational axis shown by the arrow C2. Further, in the cladding layer 34 on the partitioning wall side of the countersunk groove 33, the summit of the interface W4 moves in the vertically upward direction from the summit of the ideal interface W1, and the foot of the interface W4 moves from the foot of the ideal interface W1 toward the rotational axis. That is, the state of the processing allowance of the cladding layer 34 on both the combustion chamber wall side and the partitioning wall side becomes a so-called “over-cladded state” in which there are excess processing allowances (excess processing allowances t2 and t3) exceeding the prescribed processing allowance t1.

Next, the laser clad-welding method implemented by the laser clad welding apparatus 10 according to this embodiment is explained.

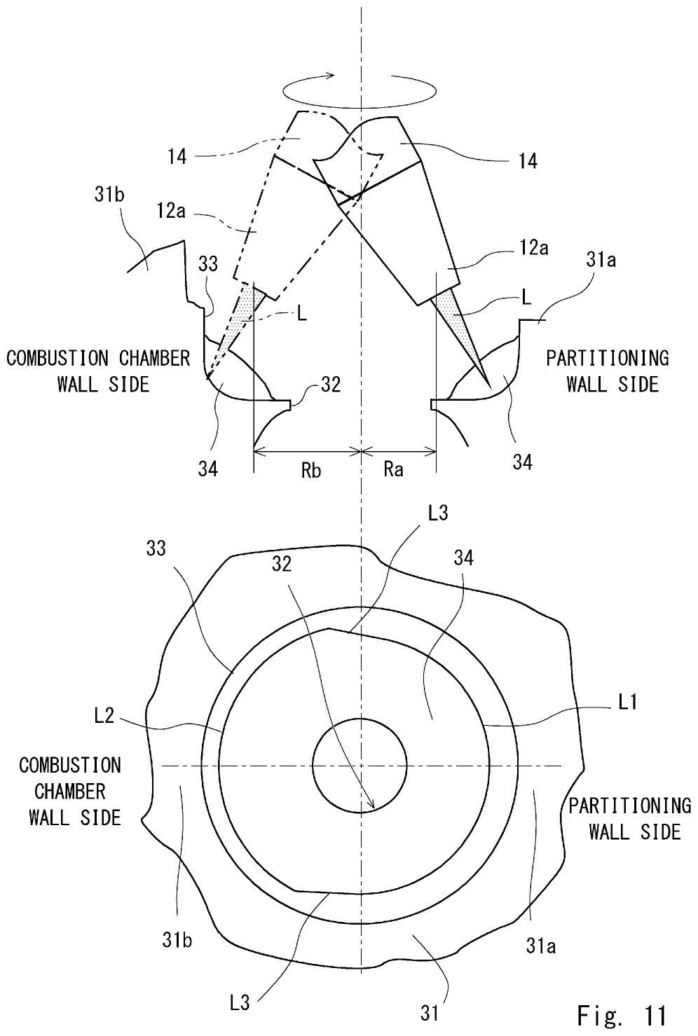

Note that in the explanation given below, FIGS. 1 and 2 are also referred to as appropriate. FIG. 11 is a schematic diagram for explaining a laser clad-welding method implemented by the laser clad-welding apparatus 10 according to this embodiment. As shown in FIG. 11, when the part of the countersunk groove 33 on the center side of the combustion chamber 31 (i.e., the partitioning wall side) is welded, a distance Ra from the central axis of the countersunk groove 33 to the irradiation locus L1 of the laser beam L is made to fall within a first distance range within which the partitioning wall 31a does not melt down. Further, when the part of the countersunk groove 33 on the outer circumferential side of the combustion chamber 31 (i.e., the combustion chamber wall side) is welded, a distance Rb from the central axis of the countersunk groove 33 to the irradiation locus L2 of the laser beam L is made to fall within a second distance range within which for the interface of the welded cladding layer 34, a prescribed processing allowance can be ensured with respect to the target interface. The control part 19 controls the actions of the rotary moving part 17 and the linear moving part 18 so that the distance Ra falls within the first distance range (Ra1≤Ra≤Ra2) when the part of the countersunk groove on the partitioning wall side is welded and falls within the second distance range (Rb1≤Rb≤Rb2) when the part of the countersunk groove on the combustion chamber wall side is welded. Note that the distance Rb is longer than the distance Ra.

By this configuration, the interface of the welded cladding layer 34 can be made the ideal interface W1. Accordingly, the processing allowance measured from the target interface of the cladding layer 34 can be adjusted to the minimum necessary processing allowance on both the combustion chamber wall side and the partitioning wall side. Further, it is possible to prevent poor quality which would otherwise be caused by the clad-welding such as the edge of the partitioning wall 31a melting down due to excessive heat from the laser beam.

Note that the control part 19 moves the laser torch 14 so that an irradiation locus L3 of the laser beam L becomes linear between the irradiation locus L1 of the laser beam irradiated to the part of the countersunk groove on the partitioning wall side and the irradiation locus L2 of the laser beam irradiated to the part of the countersunk groove on the combustion chamber wall side by controlling the actions of the rotary moving part 17 and the linear moving part 18. By this configuration, the irradiation locus L1 of the laser beam irradiated to the countersunk groove on the partitioning wall side and the irradiation locus L2 of the laser beam irradiated to the part of the countersunk groove on the combustion chamber wall side can be smoothly joined.

### Modified Example 1

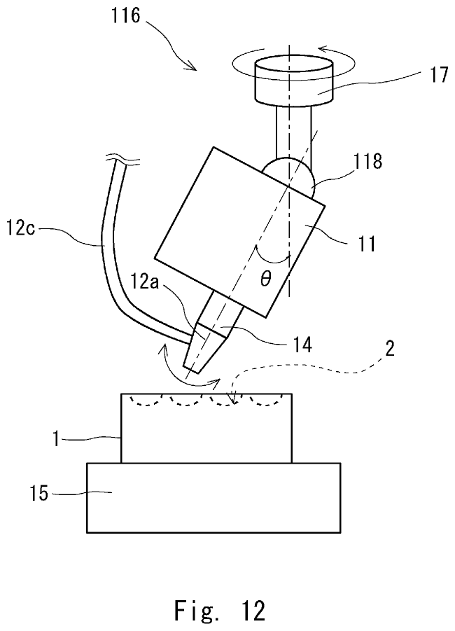

FIG. 12 is a schematic diagram showing a moving part 116 according to a Modified Example 1. As shown in FIG. 12, the moving part 116 according to the Modified Example 1 includes an angle adjustment part 118 that adjusts an angle θ, which is an angle of the laser torch 14 with respect to the vertical direction, in place of the linear moving part 18 of the moving part 16 shown in FIG. 2. The control part 19 shown in FIG. 1 controls the actions of the rotary moving part 17 and the angle adjustment part 118 while the laser beam is being irradiated. And, as explained with reference to FIG. 11, when the part of the countersunk groove 33 on the center side of the combustion chamber 31 (i.e., the partitioning wall side) is being welded, the distance Ra from the central axis of the countersunk groove 33 to the irradiation locus L1 of the laser beam L is made to fall within the first distance range within which the partitioning wall 31a does not melt down while the laser beam L is being irradiated. Further, when the part of the countersunk groove 33 on the outer circumferential side of the combustion chamber 31 (i.e., the combustion chamber wall side) is being welded, a distance Rb from the central axis of the countersunk groove 33 to the irradiation locus L2 of the laser beam L is made to fall within the second distance range within which, for the interface of the welded cladding layer 34, a prescribed processing allowance can be ensured with respect to the target interface.

That is, the control part 19 controls the action of the angle adjustment part 118 so that the angle θ of the laser torch 14 with respect to the vertical direction becomes larger when the part of the countersunk groove on the combustion chamber wall side is welded compared to the case where the part of the countersunk groove on the partition wall side is welded. By this configuration, the distance from the central axis of the countersunk groove 33 to the irradiation locus of the laser beam L when the part of the countersunk groove on the combustion chamber wall side is being welded can be made longer than the distance from the central axis of the countersunk groove 33 to the irradiation locus of the laser beam L when the part of the countersunk groove on the partitioning wall side is being welded.

### Modified Example 2

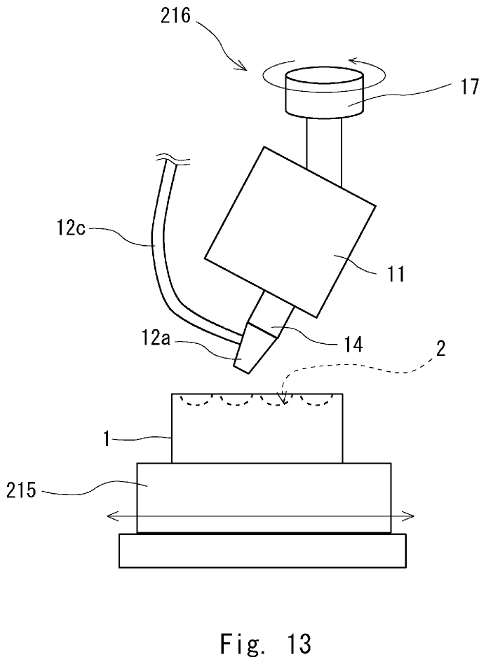

FIG. 13 is a schematic diagram showing a moving part 216 and a positioning part 215 according to a Modified Example 2. As shown in FIG. 13, the moving part 216 according to the Modified Example 2 includes only the rotary moving part 17 of the moving part 16 shown in FIG. 2 and does not include the linear moving part 18 thereof. That is, the laser torch 14 rotates with the predetermined radius of gyration in both of the cases where the part of the countersunk groove on the combustion chamber wall side is welded and the part of the countersunk groove on the partitioning wall side is welded while the laser beam L is being irradiated. The positioning part 215 is structured to be linearly moveable while the laser beam L is being irradiated. The control part 19 shown in FIG. 1 controls the actions of the rotary moving part 17 and the positioning part 215 while the laser beam is being irradiated. Further, as explained with reference to FIG. 11, when the part of the countersunk groove 33 on the center side of the combustion chamber 31 (i.e., the partitioning wall side) is welded, the distance Ra from the central axis of the countersunk groove 33 to the irradiation locus L1 of the laser beam L is adjusted so as to fall within the first distance range within which the partitioning wall 31a does not melt down while the laser beam L is being irradiated. Further, when the part of the countersunk groove 33 on the outer circumferential side of the combustion chamber 31 (i.e., the combustion chamber wall side) is welded, the distance Rb from the central axis of the countersunk groove 33 to the irradiation locus L2 of the laser beam L is adjusted so as to fall within the second distance range within which for the interface of the welded cladding layer 34, a prescribed processing allowance is ensured with respect to the target interface while the laser beam is being irradiated.

That is, while the laser beam is being irradiated, the laser torch 14 is rotated with the predetermined radius of gyration by the rotary moving part 17 and the amount of the linear movement of the positioning part 215 is controlled. By this configuration, the distance from the central axis of the countersunk groove 33 to the irradiation locus of the laser beam L when the part of the countersunk groove on the combustion chamber wall side is welded is made longer than the distance from central axis of the countersunk groove 33 to the irradiation locus of the laser beam L when the part of the countersunk groove on the partitioning wall side is welded.

As described above, in the laser clad-welding apparatus according to this embodiment, when the part of the countersunk groove on the center side of the combustion chamber is welded, the distance from the central axis of the countersunk groove to the irradiation locus of the laser beam is adjusted so as to fall within the first distance range within which the partitioning wall does not melt down while the laser beam is being irradiated. Further, when the part of the countersunk groove on the outer circumferential side of the combustion chamber is welded, the distance from the central axis of the countersunk groove to the irradiation locus of the laser beam is adjusted so as to fall within the second distance range within which for the interface of the welded cladding layer, the prescribed processing allowance is ensured with respect to the target interface while the laser beam is being irradiated. Accordingly, the processing allowance measured from the target interface of the cladding layer can be adjusted to the minimum necessary processing allowance on both the combustion chamber wall side and the partitioning wall side. Further, it is possible to prevent poor quality which would otherwise be caused by the clad-welding such as an edge of the partitioning wall melting down due to excessive heat from the laser beam.

In the laser clad-welding method implemented by the laser clad-welding apparatus 10 according to this embodiment, only the distance from the rotational axis to the tip of the laser torch needs to be offset so that the length from the central axis of the countersunk groove to the irradiation locus of the laser beam becomes longer on the combustion chamber wall side than that on the partitioning wall side. Further, since no complex control such as changing some of the control parameters during the clad-welding processing is involved, a relatively simple program can be employed. Further, in the laser clad-welding method implemented by the laser clad-welding apparatus 10 according to this embodiment, no special equipment is required and hence there is no increase in the equipment expense.

Note that the present disclosure is not limited to the embodiments mentioned above, and can be modified as appropriate without departing from the gist of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A laser clad-welding method comprising:
a first process of forming, in a blank of a cylinder head in which a hemispherical combustion chamber is formed and a plurality of port holes are radially formed in the combustion chamber, an annular countersunk groove along an outer circumference of each of the plurality of port holes; and
a second process of forming a cladding layer for a valve sheet by making a central axis of the countersunk groove coincide with a vertical direction and irradiating a laser beam to the countersunk groove while feeding metal powder to the countersunk groove, wherein
in the second process, a laser torch for irradiating the laser beam is moved so that a distance from the central axis of the countersunk groove to an irradiation locus of the laser beam falls within a first distance range within which a partitioning wall located between adjacent countersunk grooves does not melt down in a part of the countersunk groove on a center side of the combustion chamber, and a distance from the central axis of the countersunk groove to an irradiation locus of the laser beam falls within a second distance range within which, for an interface of the welded cladding layer, a prescribed processing allowance is ensured with respect to a target interface in a part of the countersunk groove on an outer circumference side of the combustion chamber.

2. The laser clad-welding method according to claim 1, wherein the laser torch is moved so that the irradiation locus of the laser beam between an irradiation locus of the laser beam irradiated to the part of the countersunk groove on the center side of the combustion chamber and an irradiation locus of the laser beam irradiated to the part of the countersunk groove on the outer circumference side of the combustion chamber becomes linear.

3. A laser clad-welding method comprising:
a first process of forming, in a blank of a cylinder head in which a hemispherical combustion chamber is formed and a plurality of port holes are radially formed in the combustion chamber, an annular countersunk groove along an outer circumference of each of the plurality of port holes; and
a second process of forming a cladding layer for a valve sheet by making a central axis of the countersunk groove coincide with a vertical direction and irradiating a laser beam to the countersunk groove while feeding metal powder to the countersunk groove, wherein
in the second process, the blank is moved so that a distance from the central axis of the countersunk groove to an irradiation locus of the laser beam falls within a first distance range within which a partitioning wall located between adjacent countersunk grooves does not melt down in a part of the countersunk groove on a center side of the combustion chamber, and a distance from the central axis of the countersunk groove to an irradiation locus of the laser beam falls within a second distance range within which for an interface of the welded cladding layer, a prescribed processing allowance is ensured with respect to a target interface in a part of the countersunk groove on an outer circumference side of the combustion chamber.

4. The laser clad-welding method according to claim 3, wherein the blank is moved so that an irradiation locus of the laser beam between an irradiation locus of the laser beam irradiated to the part of the countersunk groove on the center side of the combustion chamber and an irradiation locus of the laser beam irradiated to the part of the countersunk groove on the outer circumference side of the combustion chamber becomes linear.

5. A laser clad-welding apparatus comprising:
a positioning part configured to position a blank of a cylinder head in which a plurality of port holes are radially formed in a hemispherical combustion chamber and an annular countersunk groove is formed along an outer circumference of each of the plurality of port holes;
a metal powder feeding part configured to feed metal powder to the countersunk groove;
a laser beam irradiation part configured to form a cladding layer in the countersunk groove by irradiating a laser beam to the metal powder and thereby melting the metal powder;
a rotary moving part configured to rotate a laser torch in the laser beam irradiation part;
a linear moving part configured to linearly move the laser torch; and
a control part configured to control actions of the positioning part, the metal powder feeding part, the laser beam irradiation part, the rotary moving part, and the linear moving part,
wherein the control part controls:
the action of the positioning part so that a central axis of the countersunk groove coincides with a vertical direction;
the actions of the metal powder feeding part and the laser beam irradiation part so that the laser beam is irradiated to the countersunk groove while feeding the metal powder to the countersunk groove; and
the actions of the rotary moving part and the linear moving part so that while the laser beam is being irradiated, a distance from the central axis of the countersunk groove to an irradiation locus of the laser beam falls within a first distance range within which a partitioning wall located between adjacent countersunk grooves does not melt down in a part of the countersunk groove on a center side of the combustion chamber, and a distance from the central axis of the countersunk groove to an irradiation locus of the laser beam falls within a second distance range within which for an interface of the welded cladding layer, a prescribed processing allowance is ensured with respect to a target interface in a part of the countersunk groove on an outer circumference side of the combustion chamber.

6. A laser clad-welding apparatus comprising:
a positioning part configured to position a blank of a cylinder head in which a plurality of port holes are radially formed in a hemispherical combustion chamber and an annular countersunk groove is formed along an outer circumference of each of the plurality of port holes;
a metal powder feeding part configured to feed metal powder to the countersunk groove;
a laser beam irradiation part configured to form a cladding layer in the countersunk groove by irradiating a laser beam to the metal powder and thereby melting the metal powder;
a rotary moving part configured to rotate a laser torch in the laser beam irradiation part;
an angle adjustment part configured to adjust an angle of the laser torch with respect to a vertical direction; and
a control part configured to control actions of the positioning part, the metal powder feeding part, the laser beam irradiation part, the rotary moving part, and the angle adjustment part,
wherein the control part controls:
the action of the positioning part so that a central axis of the countersunk groove coincides with a vertical direction;
the actions of the metal powder feeding part and the laser beam irradiation part so that the laser beam is irradiated to the countersunk groove while feeding the metal powder to the countersunk groove; and
the actions of the rotary moving part and the angle adjustment part so that while the laser beam is being irradiated, a distance from the central axis of the countersunk groove to an irradiation locus of the laser beam falls within a first distance range within which a partitioning wall located between adjacent countersunk grooves does not melt down in a part of the countersunk groove on a center side of the combustion chamber, and a distance from the central axis of the countersunk groove to an irradiation locus of the laser beam falls within a second distance range within which for an interface of the welded cladding layer, a prescribed processing allowance is ensured with respect to a target interface in a part of the countersunk groove on an outer circumference side of the combustion chamber.
